(19) United States
(12) Patent Application Publication
(10) Pub. No.: US 2009/0135147 A1
(43) Pub. Date: May 28, 2009

(54) INPUT METHOD AND CONTENT DISPLAYING METHOD FOR AN ELECTRONIC DEVICE, AND APPLICATIONS THEREOF

(75) Inventors: Hung-Yang Hsu, Taipei (TW); Li-Hsuan Chen, Taipei (TW); Wen-Chin Wu, Taipei (TW); Bo-Ching Chiou, Taipei (TW); Wei-Hung Liu, Taipei (TW); Chia-Hsien Li, Taipei (TW)

Correspondence Address: LADAS & PARRY, 5670 WILSHIRE BOULEVARD, SUITE 2100, LOS ANGELES, CA, 90036-5679, US

(73) Assignee: WISTRON CORPORATION, Taipei (TW)

(21) Appl. No.: 12/130,187

(22) Filed: May 30, 2008

(30) Foreign Application Priority Data
Nov. 27, 2007 (TW) 096144940

(51) Int. Cl. G06F 3/041

(52) U.S. Cl. 345/173

(57) ABSTRACT

In an input method and an input system for an electronic device, an electronic device having input functionality and content displaying functionality, and a content displaying method and a displaying system for an electronic device, the electronic device is provided with a sensing screen, and the input method includes the following steps: displaying a plurality of virtual keys; receiving an input signal; displaying a corresponding enlarged virtual key on the sensing screen; and detecting whether there is an input of a confirm input signal, and outputting a virtual key code corresponding to the confirm input signal if affirmative.

### CROSS-REFERENCE TO RELATED APPLICATION

This application claims priority of Taiwanese Application No. 096144940, filed on Nov. 27, 2007.

### BACKGROUND OF THE INVENTION

1. Field of the Invention

The invention relates to an input method and system, and a content displaying method and system, more particularly to an input method and system for an electronic device, an electronic device having input functionality and content displaying functionality, and a content displaying method and system for an electronic device.

2. Description of the Related Art

Due to vast developments in touch screens, recently, there has been a tendency to gradually replace physical keys with virtual keys for user interfaces (UIs) of handheld mobile devices. The most well-known handheld mobile device with such user interface that is currently available is the iPhone manufactured by Apple. At present the layout of virtual keys on a touch screen available on the market is fixed, i.e., the sizes and relative positions of the virtual keys are fixed and unchangeable. However, since the fingers of every user are different in size, if the size of the touch screen is relatively small, it is very probable that the user may touch the wrong keys during inputting of information.

According to academic reports related to user interfaces, in the arrangement of physical keys, the size of each key is preferably not less than 0.8 sq. cm., and a gap between two adjacent keys is preferably not less than 0.25 cm. The width of the thumb of a male user of medium stature is approximately 2.54 cm. Judging against the aforesaid conditions, the virtual keypads of existing handheld mobile devices apparently can hardly comply with the aforesaid standard.

In addition, many people use handheld mobile devices to browse web pages or read documents so as to be able to enjoy the fun of reading information any time anywhere. However, since web pages or documents are generally designed according to the resolution of a desktop display screen, if, for instance, an entire web page is to be viewed on a touch screen (generally about 2.5 inches to 3.5 inches in dimension) of a mobile device, the content of the web page will be difficult to read because the displayed web page is too small. If only a part of the web page is viewed at a time, a lot of scrolling is required in order to read the entire content of the web page, which is rather complicated in terms of operation.

In order to overcome the aforesaid drawback so that the user interface of a handheld mobile device is easier and more convenient to use, there is a need to find a solution.

### SUMMARY OF THE INVENTION

Therefore, a first object of the present invention is to provide an input method for an electronic device. Accordingly, the input method of the present invention is adapted for use in an electronic device provided with a sensing screen, and includes the following steps: displaying a plurality of virtual keys on the sensing screen; receiving an input signal provided by the sensing screen; displaying an enlarged virtual key corresponding to the input signal on the sensing screen; detecting whether there is an input of a confirm input signal provided by the sensing screen; and outputting a virtual key code corresponding to the confirm input signal upon detection of the confirm input signal.

A second object of the present invention is to provide a content displaying method for an electronic device.

Accordingly, the content displaying method of the present invention is adapted for use in an electronic device provided with a sensing screen, and includes the following steps: displaying a graphics/text screen on the sensing screen; receiving an input signal provided by the sensing screen and obtaining a touch position from the input signal; displaying a local enlarged screen obtained by enlarging a portion of the graphics/text screen in the vicinity of the touch position; detecting whether there is an input of a confirm input signal provided by the sensing screen; and positioning the local enlarged screen and setting the local enlarged screen to an advanced operating state if the confirm input signal is detected.

A third object of the present invention is to provide an electronic device having input functionality.

Accordingly, the electronic device having input functionality of the present invention includes a screen sensing input unit and a processing unit. The screen sensing input unit includes a sensing screen-capable of generating an input signal and a confirm input signal. The processing unit is connected electrically to the screen sensing input unit. The processing unit includes a screen outputting module, a detecting module, and a determining module. The screen outputting module is used to generate a plurality of virtual keys for display on the sensing screen. The detecting module is used to receive the input signal and the confirm input signal from the sensing screen. The determining module enables display of a corresponding enlarged virtual key on the sensing screen through the screen outputting module for operation by a user upon detection of the input signal by the detecting module, and outputs a virtual key code corresponding to the confirm input signal upon detection of the confirm input signal by the detecting module.

A fourth object of the present invention is to provide an electronic device having content displaying functionality.

Accordingly, the electronic device having content displaying functionality of the present invention includes a screen sensing input unit and a processing unit. The screen sensing input unit includes a sensing screen capable of generating an input signal and a confirm input signal. The sensing screen is capable of displaying a graphics/text screen. The processing unit is connected electrically to the screen sensing input unit, and includes a screen outputting module, a detecting module, and a determining module. The screen outputting module is used to process the graphics/text screen for display on the sensing screen. The detecting module is used to receive the input signal and the confirm input signal from the sensing screen. The determining module computes a touch position according to the input signal. The determining module enables display on the sensing screen of a local enlarged screen in the vicinity of the touch position through the screen outputting module upon detection of the input signal by the detecting module, and positions the local enlarged screen through the screen outputting module and sets the local enlarged screen to an advanced operating state upon detection of the confirm input signal by the detecting module.

A fifth object of the present invention is to provide an input system for an electronic device.

Accordingly, the input system of the present invention is adapted for use in an electronic device provided with a sensing screen. The input system includes a screen outputting module, a detecting module and a determining module. The screen outputting module is used to generate a plurality of virtual keys for display on the sensing screen. The detecting module is used to receive an input signal and a confirm input signal from the sensing screen. The determining module is used to enable display of a corresponding enlarged virtual key on the sensing screen through the screen outputting module for operation by a user upon detection of the input signal by the detecting module, and outputs a virtual key code corresponding to the confirm input signal upon detection of the confirm input signal by the detecting module.

A sixth object of the present invention is to provide a content displaying system for an electronic device.

Accordingly, the content displaying system of the present invention is adapted for use in an electronic device provided with a sensing screen capable of displaying a graphics/text screen. The content displaying system includes a screen outputting module, a detecting module, and a determining module. The screen outputting module is used to process the graphics/text screen for display on the sensing screen. The detecting module is used to receive an input signal and a confirm input signal from the sensing screen. The determining module is used to compute a touch position according to the input signal, enables display on the sensing screen of a local enlarged screen in the vicinity of the touch position through the screen outputting module upon detection of the input signal by the detecting module, and positions the local enlarged screen through the screen outputting module and sets the local enlarged screen to an advanced operating state upon detection of the confirm input signal by the detecting module.

The effects of the present invention reside in the improvement of the flexibility of inputting via the virtual keys without increasing hardware costs, and in the enhancement of input accuracy and the reduction of input errors. In addition, the content displaying functionality of the electronic device of the present invention is more user-friendly.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram to illustrate first, second and fourth preferred embodiments of an electronic device having input functionality according to the present invention;

FIG. 2 is a flowchart to illustrate first and second preferred embodiments of an input method for an electronic device according to the present invention;

FIG. 3 is a schematic diagram to illustrate how an input signal is generated in the first preferred embodiment;

FIG. 4 is a schematic diagram to illustrate how a confirm input signal is generated in the first preferred embodiment;

FIG. 5 is a schematic diagram to illustrate how a confirm input signal is generated in the second preferred embodiment;

FIG. 6 is a schematic diagram to illustrate a third preferred embodiment of an electronic device having input functionality according to the present invention;

FIG. 7 is a schematic diagram to illustrate a modified form of the third preferred embodiment;

FIG. 8 is a flowchart to illustrate a third preferred embodiment of an input method for an electronic device according to the present invention;

FIG. 9 is a schematic diagram to illustrate how an input signal is generated in the third preferred embodiment of the input method;

FIG. 10 is a schematic diagram to illustrate how an input signal is generated in a modified form of the third preferred embodiment of the input method;

FIG. 11 is a schematic diagram to illustrate how a confirm input signal is generated in the third preferred embodiment of the input method;

FIG. 12 is a schematic diagram to illustrate how a confirm input signal is generated in another modification of the third preferred embodiment of the input method;

FIG. 13 is a schematic diagram to illustrate first, second and third sensing areas in the fourth preferred embodiment of the electronic device having input functionality;

FIG. 14 is a flowchart to illustrate a fourth preferred embodiment of an input method for an electronic device according to the present invention;

FIG. 15 is a schematic diagram to illustrate how an input signal is generated in the fourth preferred embodiment of the input method;

FIG. 16 is a schematic diagram to illustrate how a confirm input signal is generated in the fourth preferred embodiment of the input method;

FIG. 17 is a schematic diagram to illustrate first and second preferred embodiments of an electronic device having content displaying functionality according to the present invention;

FIG. 18 is a flowchart to illustrate a first preferred embodiment of a content displaying method for an electronic device according to the present invention;

FIG. 19 is a schematic diagram to illustrate how an input signal is generated in the first preferred embodiment of the content displaying method;

FIG. 20 is a schematic diagram to illustrate how a confirm input signal is generated in the first preferred embodiment of the content displaying method;

FIG. 21 is a schematic diagram to illustrate how a full-screen graphics/text screen can be restored in the first preferred embodiment of the content displaying method;

FIG. 22 is a flowchart to illustrate a second preferred embodiment of a content displaying method for an electronic device according to the present invention;

FIG. 23 is a schematic diagram to illustrate how a confirm input signal is generated in the second preferred embodiment of the content displaying method; and

FIG. 24 is a schematic diagram to illustrate how a full-screen graphics/text screen can be restored in the second preferred embodiment of the content displaying method.

### DETAILED DESCRIPTION OF THE PREFERRED EMBODIMENTS

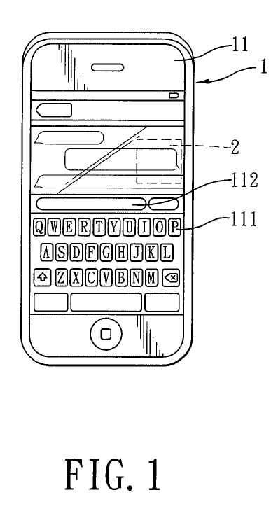

Referring to FIG. 1, the first preferred embodiment of an electronic device having input functionality of this invention is shown to include a screen sensing input unit 1 and a processing unit 2.

The screen sensing input unit 1 is a capacitive touch screen device in this preferred embodiment but is not limited thereto in other embodiments. The screen sensing input unit 1 may also be a touch screen device capable of detecting touch pressures so as to support multi-touch, and the like. The screen sensing input unit 1 includes a sensing screen 11. When a user touches the sensing screen 11 with different degrees of pressure using at least one object (such as a finger, a stylus, or any other implements), the sensing screen 11 will generate different current signals. In the first preferred embodiment, the sensing screen 11 is a touch panel. During design, a current signal generated as a result of touching of the sensing screen 11 by the user with a first pressure may be defined as an input signal, and a current signal generated as a result of touching of the sensing screen 11 by the user with a second pressure that is greater than the first pressure may be defined as a confirm input signal. The first pressure is generated by a soft touch of the sensing screen 11, whereas the second pressure is generated by a firm touch of the sensing screen 11. In addition, the sensing display 11 can display a plurality of virtual keys 111 and other information. In the first preferred embodiment, the virtual keys 111 respectively show the twenty-six letters of the English alphabet, A to Z, but the present invention is not limited thereto in practice. For different fields of application, the virtual keys 111 may also be configured to show other types of characters or signs. In addition, the other information displayed on the sensing screen 11 includes a text input frame 112 in which corresponding letters A to Z will appear in response to operation of the virtual keys 111 by the user.

The processing unit 2 is connected to the screen sensing input unit 1, and includes a screen outputting module (not shown), a detecting module (not shown), and a determining module (not shown). In the first preferred embodiment, the processing unit 2 is a central processing unit (CPU) disposed in the electronic device, and is used to process programs. The processing unit 2 is connected to the screen sensing input unit 1 by hardware wiring. The aforesaid screen outputting module, detecting module and determining module are integrated into a program for operation by the processing unit 2 so that the processing unit 2 has combined specific functions. The screen outputting module is used to generate the virtual keys 111 for display on the sensing screen 11. The detecting module is used to receive the input and confirm input signals from the sensing screen 11. When the detecting module detects an input signal generated as a result of touching of one of the virtual keys 111 by the user, the determining module enables display of a corresponding enlarged virtual key 113 on the sensing screen 11 through the screen outputting module for operation by the user. When a confirm input signal is detected by the detecting module, the determining module outputs a virtual key code corresponding to the confirm input signal. However, the screen outputting module, the detecting module, and the determining module are not limited to software for operation by the processing unit 2. In practice, they may also be configured to be a dedicated chip for implementation as hardware.

Additionally, in the first preferred embodiment, the processing unit 2 further executes a word processing program. The aforesaid text input frame 112 is generated by the word processing program.

Referring to FIGS. 1 2 and 3, the first preferred embodiment of an input method for an electronic device according to the present invention is adapted for use in the aforesaid electronic device having input functionality. The input method includes the following steps:

First, in step 911, the sensing screen 11 of the screen sensing input unit 1 displays the virtual keys 111. In this embodiment, it is supposed that the user has already inputted two letters “A” and “_” so that the two letters “A” and “N” and an underline ” are displayed in the text input frame 112. The underline “_” indicates where the next letter will appear when the user enters further data.

Subsequently, in step 912, the processing unit 2 detects whether the user uses an object (e.g., a finger) to touch the sensing screen 11 with the first pressure (a soft touch) to result in generation of an input signal. If yes, the flow goes to step 913, in which the processing unit 2 receives the input signal. If no, the processing unit 2 continues to detect whether there is any input signal.

Thereafter, in step 914, supposing the user uses a finger 3 to touch the virtual key 111 with the letter “D” lightly, an enlarged virtual key 113 with the letter “D” is displayed on the sensing screen 11 above the virtual key 111 with the letter “D”. The enlarged virtual key 113 allows the user to clearly identify the virtual key 111 which he/she touches.

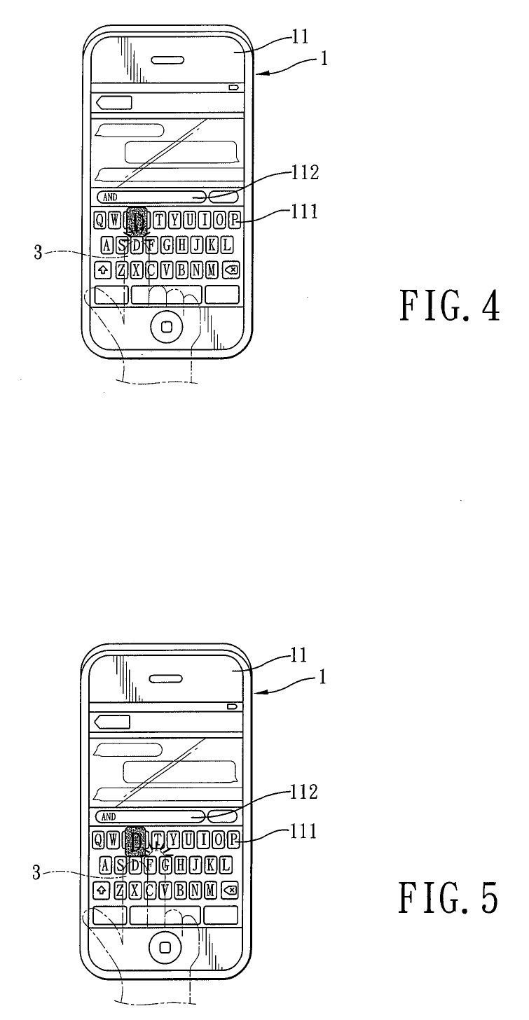

Next, in step 915, the processing unit 2 detects whether the user touches the sensing screen 11 with the second pressure (a firm touch) to result in generation of a confirm input signal. If yes, the processing unit 2 detects the confirm input signal, and detects that the confirm input signal is generated at the position of the virtual key 111 with the letter “D” which was touched lightly previously. Then, in step 916, as shown in FIG. 4, the processing unit 2 executes a confirmation prompt and outputs a virtual key code corresponding to the confirm input signal. At this time, the letter “D” will appear in the text input frame 112. The confirmation prompt may be a background color displayed on the enlarged virtual key 113 with the letter “D” (or a voiced confirmation prompt).

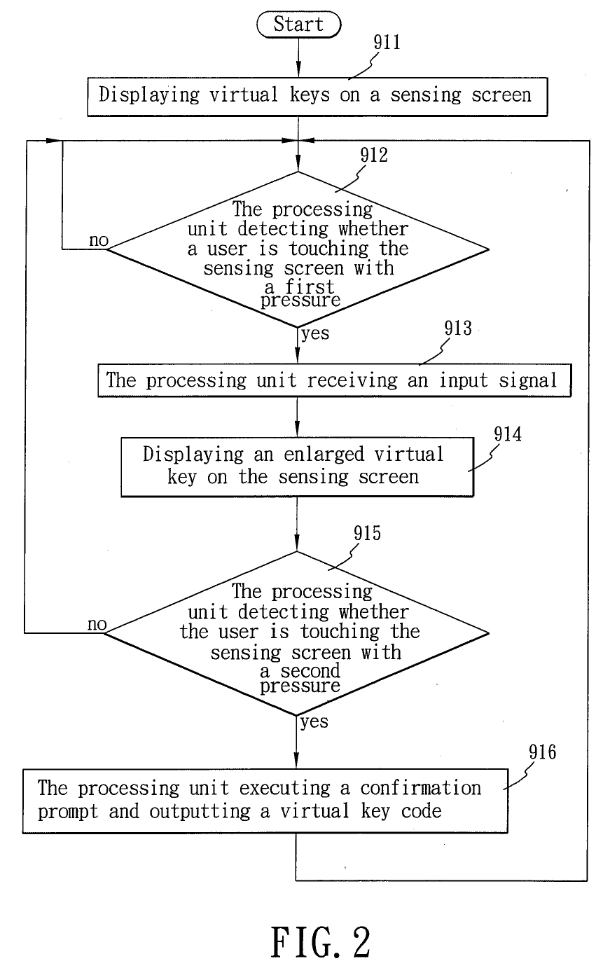

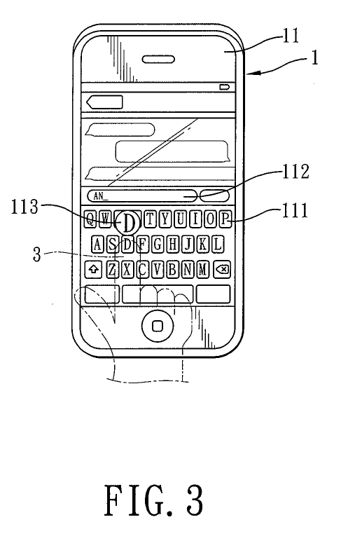

Referring to FIG. 1, the second preferred embodiment of an electronic device having input functionality of this invention is substantially similar to the first preferred embodiment, and includes a screen sensing input unit 1 supporting multi-touch, and a processing unit 2. However, unlike the first preferred embodiment, while the first pressure is generated by touching the sensing screen 1 lightly with one object in this embodiment, the second pressure is generated by touching the sensing screen 11 simultaneously using two objects (e.g., index and middle fingers). Referring to FIGS. 1 and 2, the second preferred embodiment of an input method for an electronic device according to the present invention is substantially similar to the first preferred embodiment, and is adapted for use in the aforesaid electronic device having input functionality. Steps of the method that are different from those of the first preferred embodiment are described below.

In step 915, the processing unit 2 detects whether the user simultaneously uses two objects to touch the sensing screen 11 with a second pressure (the second pressure as used herein refers to multi-touch input) to result in generation of a confirm input signal. Referring to FIG. 5, in the second preferred embodiment, multi-touch refers to the user touching the virtual key 111 with the letter “D” using his/her index finger 3 and substantially simultaneously touching an area adjacent to the virtual key 111 with the letter “D” using his/her middle finger 3.

If the user touches the sensing screen 11 with a second pressure, the processing unit 2 detects the confirm input signal, and determines that the confirm input signal is generated at the position of the virtual key 111 (with the letter “D”) that is touched lightly. Then, in step 916, as shown in FIG. 5, a confirmation prompt is outputted, and a virtual key code corresponding to the confirm input signal is also outputted. At this time, the letter “D” correspondingly appears in the text input frame 112.

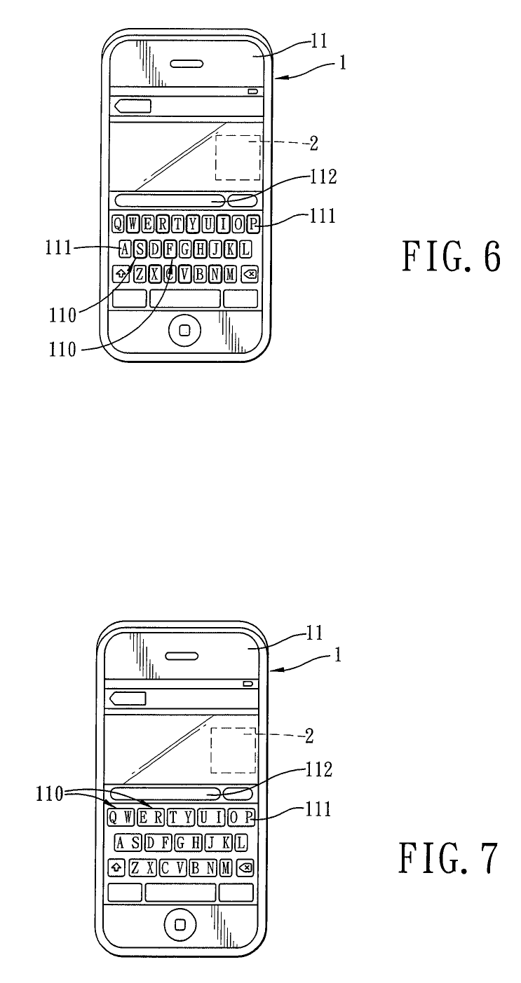

Referring to FIG. 6, the third preferred embodiment of an electronic device having input functionality of this invention is substantially the same as the first preferred embodiment, and includes a screen sensing input unit 1 and a processing unit 2. However, unlike the first preferred embodiment, the screen sensing input unit 1 in this embodiment supports a single-touch touch screen (such as a resistive touch screen), or a multi-touch touch screen (such as a capacitive touch screen). The sensing screen 11 displays a plurality of virtual keys 111 (representing the twenty-six letters of the English alphabet) and other information. However, in the third preferred embodiment, the virtual keys 111 are displayed in virtual key groups 110 when operated by the user. One of the virtual keys 111 in each virtual key group 110 is displayed conspicuously by displaying the letter on the virtual key 111 in boldface, or by displaying the virtual key 111 with a thick border, a blinking effect, or a comparatively high luminosity. For example, as shown in FIG. 6, the virtual keys 111 with the letters “A,” “S” and “D” form one-virtual key group 110, and the virtual keys “D,” “F” and “G” form another virtual key group 110, in which the virtual keys 111 with the letters “S” and “F” are each displayed with a thick border.

Referring to FIG. 7, aside from the arrangement shown in FIG. 6 in which the virtual keys 111 are grouped in units of three, in a modification of the third preferred embodiment of this invention, each virtual key group 110 is formed from two virtual keys 111. For instance, the virtual keys 111 with the letters “A” and “S” form one virtual key group 110, the virtual keys 111 with the letters “D” and “F” form another virtual key group 110, and so forth. Each virtual key group 110 is displayed as a comparatively large elongated key.

In addition, a current signal generated as a result of a touch (whether soft or firm) of the sensing screen 11 is defined as an input signal, and a current signal generated as a result of a gliding touch of the sensing screen 11 is defined as a confirm input signal. It should be noted that the position where the input signal is generated must correspond to the position of the virtual key 111 that is conspicuously displayed (such as the virtual keys 111 with the letters “S,” “F,” etc.). If the user touches a virtual key 111 that is not conspicuously displayed (such as the virtual keys 111 with the letters “A,” “D,” “G,” etc.), the input signal is set to be an invalid signal. Since each adjacent pair of the valid virtual keys 111, i.e., the conspicuously displayed virtual keys 111 with the letters “S,” “F,” etc., are spaced apart from each other by one other virtual key 111, it is not likely that the valid virtual keys 111 are touched by mistake.

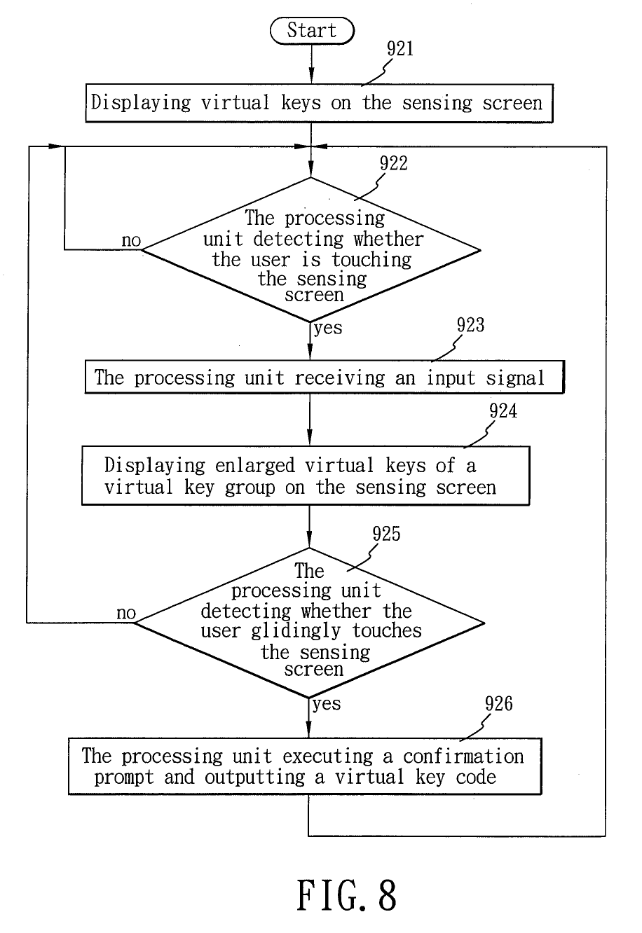

Referring to FIGS. 6, 8 and 9, the third preferred embodiment of an input method for an electronic device according to the present invention is adapted for use in the aforesaid electronic device having input functionality. The input method includes the following steps.

Initially, in step 921, the sensing screen 11 of the screen sensing input unit 1 displays the virtual keys 111. In this embodiment, it is supposed that the user has already inputted three letters “L,” “E” and “A,” so that the three letters “L,” “E” and “A,” and an underline “_” are displayed in the text input frame 112. The underline “_” indicates where the next letter will appear when the user enters further data.

Subsequently, in step 922, the processing unit 2 detects whether the user touches the sensing screen 11 using an object (such as a finger) to result in generation of an input signal. If yes, in step 923, the processing unit 2 receives the input signal. If no, the processing unit 2 continues to detect presence of any input signal.

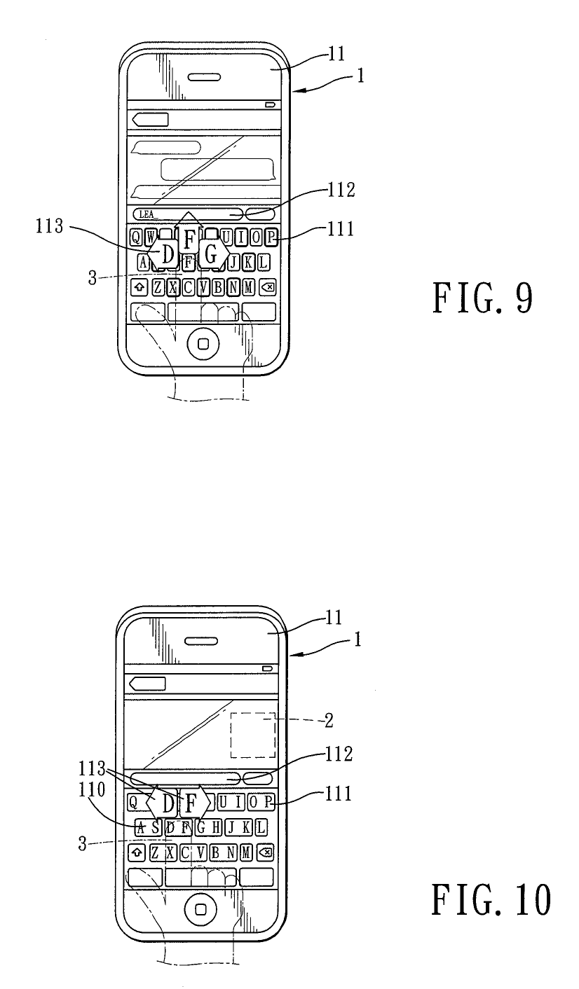

Thereafter, in step 924, supposing the user uses his/her finger 3 to touch the virtual key 111 with the letter “F,” the sensing screen 11 displays, in addition to displaying an enlarged virtual key 113 with the letter “F,” enlarged virtual keys 113 showing the letters “D” and “G” which are in the same virtual key group 110 as the virtual key 111 with the letter “F” are also displayed. Moreover, as shown in FIG. 9, each enlarged virtual key 113 has an outer edge configured to be a sign with a direction prompting function. The enlarged virtual keys 113 enable the user to clearly identify the virtual key 111 that the user is touching and those that are available for selection.

It is particularly noted that, in the modification of the embodiment as shown in FIG. 7, if the virtual key group 110 with the letters “D” and “F” is touched lightly by the finger 3 of the user, in step 924 and as shown in FIG. 10, the enlarged virtual keys 113 with the letters “D” and “F” are displayed on the sensing screen 11 above and adjacent to the virtual key group 110 that is touched. Moreover, as shown in FIG. 10, the outer edge of each enlarged virtual key 113 is configured to be a sign with a direction prompting function.

Subsequently, in step 925, the processing unit 2 detects whether the user uses an object to glidingly touch the sensing screen 11 to result in generation of a confirm input signal. If no, the processing unit 2 continues-to detect presence of any input signal.

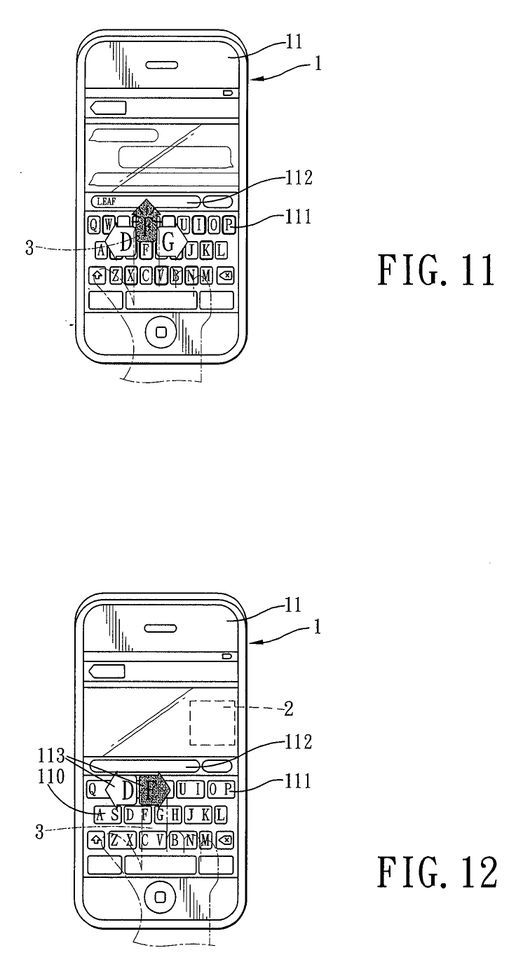

If the processing unit 2 detects a confirm input signal, and the confirm input signal is generated in a direction of one of the enlarged virtual keys 113, in step 926 and as shown in FIG. 11, the processing unit 2 executes a confirmation prompt and outputs a virtual key code corresponding to the confirm input signal. For instance, if the confirm input signal is generated as a result of upward gliding movement of the user's finger 3 on the sensing screen 11 (i.e., at the enlarged virtual key 113 with the letter “F”), the letter “F” will correspondingly appear in the text input frame 112, and a background color of the enlarged virtual key 113 with the letter “F” will be displayed to serve as the confirmation prompt.

Similarly, for the modification of the embodiment as shown in FIG. 7, the processing unit 2 executes a confirmation prompt and outputs a virtual key corresponding to the confirm input signal in step 926 and as shown in FIG. 12. For instance, if the confirm input signal is generated as a result of rightward gliding movement of the user's finger 3 on the sensing screen 11 (i.e., at the enlarged virtual key 113 with the letter “F”), the letter “F” will correspondingly appear in the text input frame 112, and a background color of the enlarged virtual key 113 with the letter “F” is displayed to serve as the confirmation prompt.

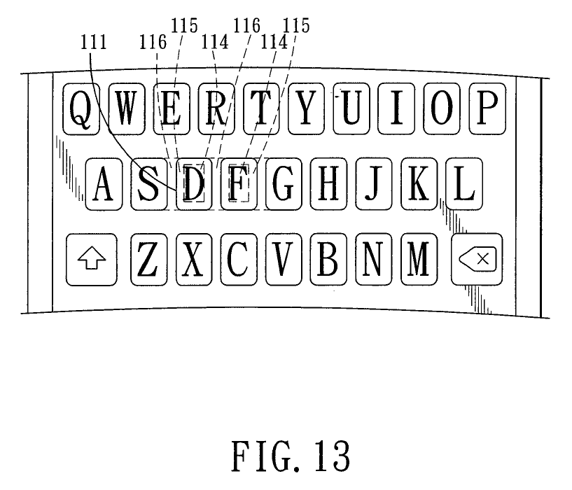

Referring to FIGS. 1 and 13, the fourth preferred embodiment of an electronic device having input functionality according to the present invention is substantially similar to the third preferred embodiment, and includes a screen sensing input unit 1 and a processing unit 2. However, unlike the third preferred embodiment, the virtual keys 111 are not shown in groups on the sensing screen 11. Instead, in addition to the virtual keys 111 displayed by the sensing screen 11 of the screen sensing input unit 1, the processing unit 2 sets, in accordance with the virtual keys 111, a plurality of first sensing areas 114 located respectively at central portions of the virtual keys 111 and corresponding respectively to the virtual keys 111, a plurality of second sensing areas 115 located respectively at outer peripheral portions of the virtual keys 111 and corresponding respectively to the virtual keys 111, and a plurality of third sensing areas 116 located among the virtual keys 111. For instance, for the virtual keys 111 with the letters “D” and “F,” the central portion of each of these virtual keys 111 is the first sensing area 114, the area surrounding each of these virtual keys 111 is the second sensing area 115, and the area between these two virtual keys 111 is the third sensing area 116.

When the user touches the first, second and third sensing areas 114, 115, 116 using an object, (such as a finger), although input signals are generated, the input signals are different. For the virtual key 111 with the letter “D,” for instance, when the first sensing area 114 thereof is touched, the processing unit 2 directly outputs a virtual key code corresponding to a confirm input signal, so that the letter “D” appears in the text input frame 112. If the third sensing area 116 between the virtual keys 111 with the letters “D” and “F,” the right side of the second sensing area 115 of the virtual key 111 with the letter “D,” or the left side of the second sensing area 115 of the virtual key 111 with the letter “F” is touched, it will be considered to be an indefinite touch, and the sensing screen 11 will display both the enlarged virtual keys 113 with the letters “D” and “F” for confirmation by the user.

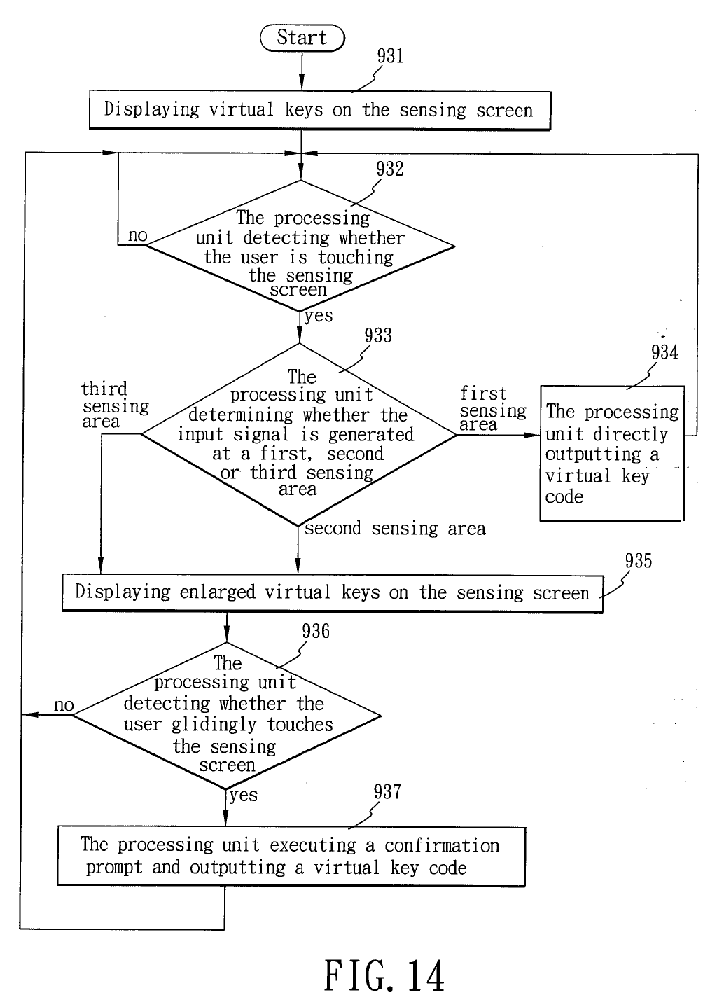

Referring to FIGS. 1, 13 and 14, the fourth preferred embodiment of an input method for an electronic device according to the present invention is adapted for use in the aforesaid electronic device having input functionality. The input method includes the following steps:

Initially, in step 931, the sensing screen 11 of the screen sensing input unit 1 displays the virtual keys 111.

Subsequently, in step 932, the processing unit 2 detects whether the user uses an object (e.g., a finger) to touch the sensing screen 11 to result in generation of an input signal. If yes, in step 933, the processing unit 2 determines whether the received input signal is generated at one of the first, second and third sensing areas 114, 115, 116. If no, the processing unit 2 continues to detect presence of any input signal.

In step 933, if the processing unit 2 determines that the input signal is generated at the first sensing area 114, the flow goes to step 934, in which the processing unit 2 directly outputs a virtual key code corresponding to the input signal.

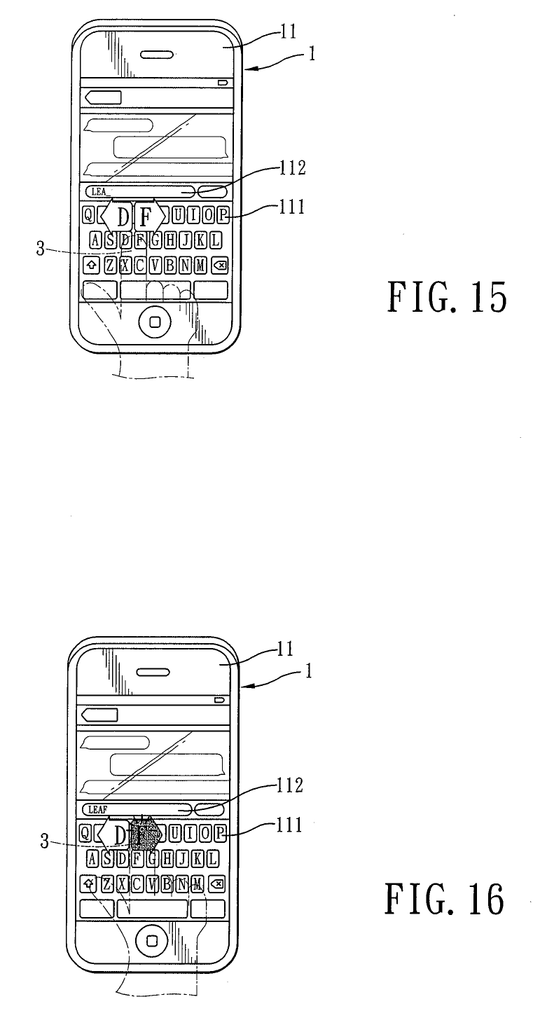

As shown in FIGS. 1, 13 and 15, if the processing unit 2 determines in step 933 that the input signal is generated at the third sensing area 116 between the virtual keys 111 with the letters “D” and “F,” the right side of the second sensing area 115 of the virtual key 111 with the letter “D,” or the left side of the second sensing area 115 of the virtual key 111 with the letter “F,” the flow goes to step 935, in which enlarged virtual keys 113 corresponding to the virtual keys 111 with the letters “D” and “F” are displayed on the sensing screen 11 above the corresponding virtual keys 111. Each of the displayed enlarged virtual keys 113 has an outer edge configured to be a sign with a direction prompting function.

Thereafter, in step 936, the processing unit 2 detects whether the user uses an object to glidingly touch the sensing screen 11 to generate a confirm input signal. For instance, as shown in FIG. 16, the finger 3 of the user glides rightward to where the enlarged virtual key 113 with the letter “F” is. In step 937, the processing unit 2 detects the confirm input signal and determines that the confirm input signal is generated in a direction of one of the enlarged virtual keys 113. Accordingly, the processing unit 2 executes a confirmation prompt and outputs a virtual key code corresponding to the confirm input signal, so that the letter “F” correspondingly appears in the text input frame 112, as shown in FIG. 16, and a background color of the enlarged virtual key 113 with the letter “F” is displayed to serve as the confirmation prompt.

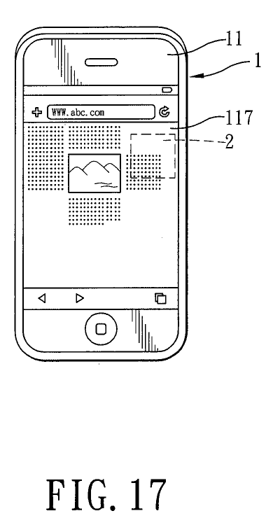

Referring to FIG. 17, the first preferred embodiment of an electronic device having content displaying functionality according to the present invention includes a screen sensing input unit 1 and a processing unit 2.

The screen sensing input unit 1 is a capacitive touch screen device in this preferred embodiment but is not limited thereto in other embodiments of this invention. The screen sensing input unit 1 may also be a touch screen device capable of detecting touch pressures so as to support multi-touch, etc. The screen sensing input unit 1 includes a sensing screen 11. When a user touches the sensing screen 11 with different degrees of pressure using at least one object (such as a finger, a stylus, or any other implements), the sensing screen 11 will generate different current signals. In the first preferred embodiment, a current signal generated in response to touching of the sensing screen 11 by the user with a first pressure is defined as an input signal, and a current signal generated in response to touching of the sensing screen 11 by the user with a second pressure that is greater than the first pressure is defined as a confirm input signal. The first pressure is generated as a result of a soft touch of the sensing screen 11, whereas the second pressure is generated as a result of a firm touch of the sensing screen 11. In addition, the sensing screen 11 displays a graphics/text screen 117. In the first preferred embodiment, the graphics/text screen 117 is that of hypertext with content that includes images, text, and hypertext links, such as a web page, but is not limited thereto. The graphics/text screen 117 may also be that of documents in other file formats. It should be noted that, since the sensing screen 11 is used by a portable mobile device, the viewable area of the sensing screen 11 is much smaller than that of a display of a personal computer, so that although the graphics/text screen 117 can provide a fully zoomed out page, the text on the graphics/text screen 117 may be too small to be identifiable, and details of the images may not be discernible.

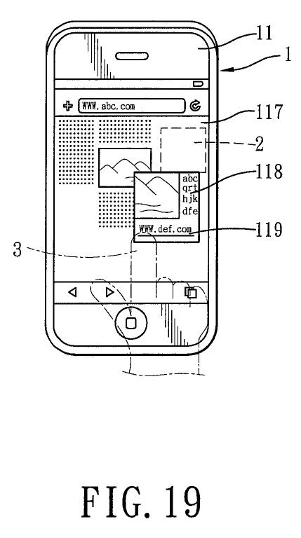

The processing unit 2 is connected to the screen sensing input unit 1, and includes a screen outputting module (not shown), a detecting module (not shown), and a determining module (not shown). In the first preferred embodiment of the electronic device having content displaying functionality, the processing unit 2 is a central processing unit (CPU) disposed in the electronic device, and is used to process programs. The processing unit 2 is connected to the screen sensing input unit 1 by hardware wiring. The aforesaid screen outputting module, detecting module and determining module are integrated into a program for operation by the processing unit 2 so that the processing unit 2 has combined specific functions. The screen outputting module processes the graphics/text screen 117 for display on the sensing screen 11. The detecting module receives the input signal and the confirm input signal from the sensing screen 11. The determining module computes a touch position according to the input signal. When the detecting module detects the input signal, the determining module enables display of a local enlarged screen 118, such as that shown in FIG. 19, on the sensing screen 11 in the vicinity of the touch position through the screen outputting module. In the local enlarged screen 118, both text and graphics can be clearly displayed. When the detecting module detects the confirm input signal, the determining module positions the local enlarged screen 118 through the screen outputting module, and sets the local enlarged screen 118 to an advanced operating state. Take the web page as an example to illustrate the first preferred embodiment. Since the web page includes at least one hypertext link 119 for connecting to another web page, the aforesaid advanced operating state is the provision of the hypertext link 119 that the user can select by clicking. However, the screen outputting module, the detecting module, and the determining module are not limited to software for operation by the processing unit 2. In practice, they may be fabricated into a dedicated chip for implementation as hardware.

Additionally, in the first preferred embodiment of the electronic device having content displaying functionality, the processing unit 2 further executes a network browsing program, and displays the graphics/text screen 117 on the sensing screen 11 through the screen outputting module.

If it is desired to close the positioned local enlarged screen 118, the user can touch the part of the sensing screen 11 outside the local enlarged screen 118. When an input signal generated outside the local enlarged screen 118 is received from the sensing screen 11, the determining module of the processing unit 2 will immediately close the local enlarged screen 118.

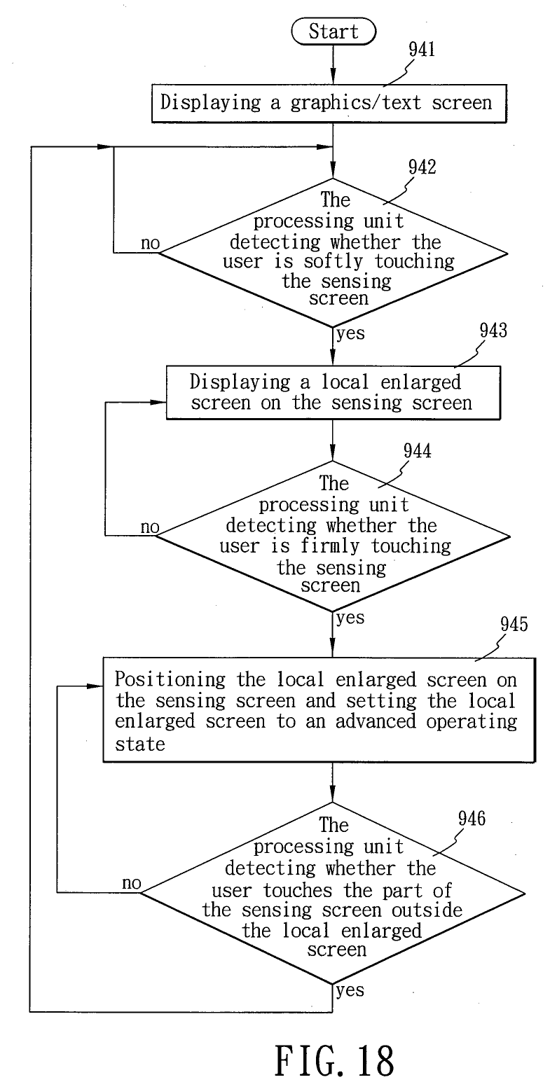

Referring to FIGS. 17 and 18, the first preferred embodiment of a content displaying method for an electronic device according to the present invention is adapted for use in the aforesaid electronic device having content displaying functionality, and includes the following steps.

Initially, in step 941, the sensing screen 11 of the screen sensing input unit 1 displays a graphics/text screen 117.

Subsequently, in step 942, the processing unit 2 detects whether the sensing screen 11 is touched by the user with a first pressure (soft touch) using an object (e.g., a finger) to result in generation of an input signal. If yes, the flow goes to step 943, in which a local enlarged screen 118 is displayed on the sensing screen 11 in the vicinity where the touch screen 11 was touched, as shown in FIG. 19. If no, the processing unit 2 continues to detect presence of any input signal.

Thereafter, in step 944, the processing unit 2 detects whether the sensing screen 11 is touched by the user with a second pressure (firm touch) using an object to result in generation of a confirm input signal. If yes, the flow goes to step 945, in which the local enlarged screen 118 on the sensing screen 11 is positioned, and is set to an advanced operating state, as shown in FIG. 19. If the user touches the hypertext link 119 under the advanced operating state, the currently displayed web page will be replaced by another web page associated with the hypertext link 119.

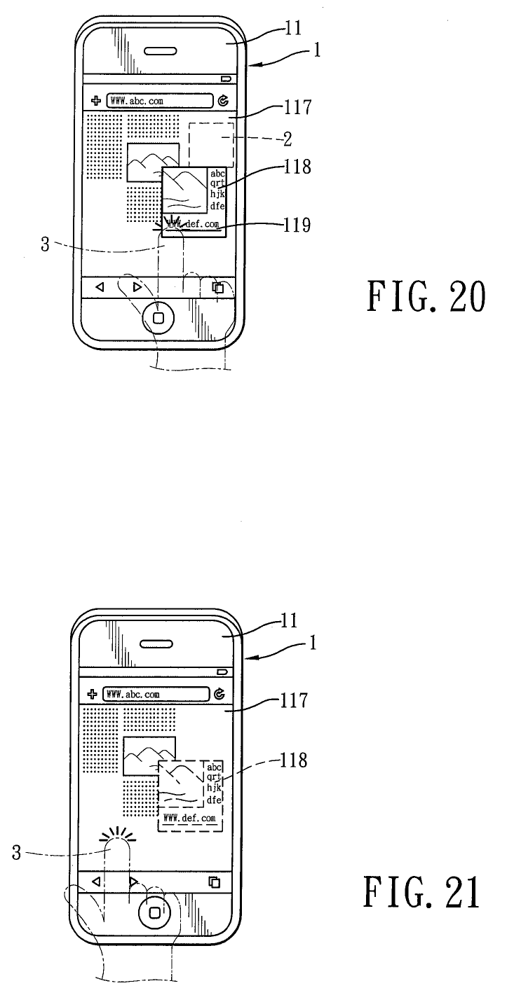

Subsequently, with further reference to FIG. 21, the flow goes to step 946, in which the processing unit 2 detects whether the user is using his/her finger 3 to touch a spot of the sensing screen 11 outside the local enlarged screen 118 with any degree of pressure to result in generation of an input signal or a confirm input signal. If yes, the sensing screen 11 will return to the full-screen graphics/text screen 117, such as that shown in FIG. 17. If no, the local enlarged screen 118 positioned on the sensing screen 11 is maintained, as shown in FIG. 20.

Referring to FIG. 17, the second preferred embodiment of an electronic device having content displaying functionality according to the present invention is substantially similar to the first preferred embodiment, and includes a screen sensing input unit 1 and a processing unit 2. However, unlike the first preferred embodiment, the first pressure in the second preferred embodiment is generated by softly touching the sensing screen 11 such that the processing unit 2 detects a touch at a touch point on the sensing screen 11, and the second pressure is generated by two objects (e.g., both the index and middle fingers 3) simultaneously touching the sensing screen 11 such that the processing unit 2 detects touching at two touch points on the sensing screen 11. In addition, referring to FIGS. 17 and 24, when the processing unit 2 positions the local enlarged screen 118, the local enlarged screen 118 is fully zoomed out to fit the viewable area of the sensing screen 11.

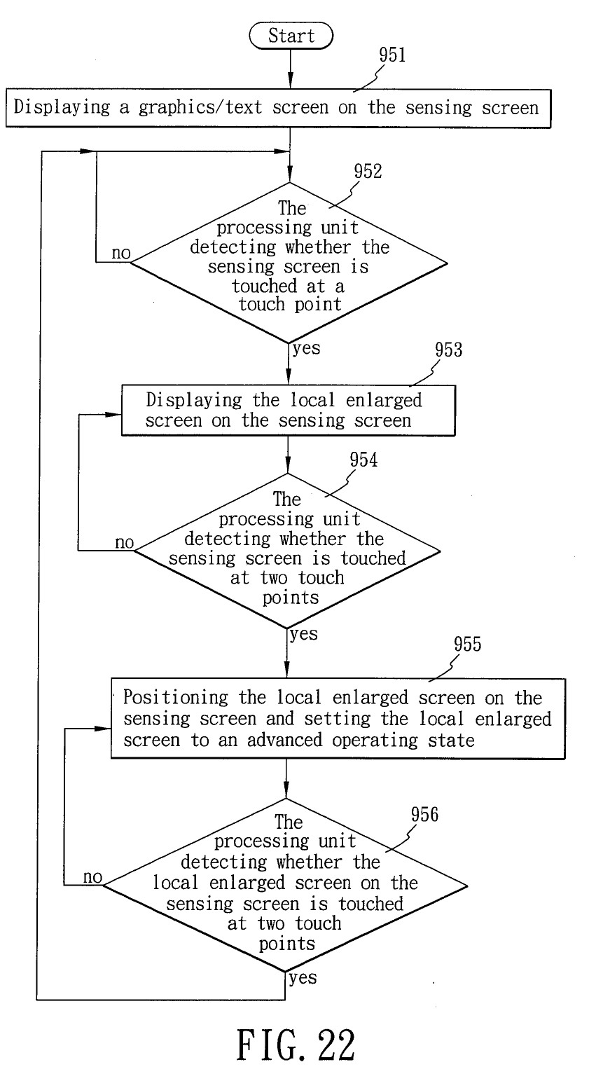

Referring to FIGS. 17 and 22, the second preferred embodiment of a content displaying method for an electronic device according to the present invention is adapted for use in the aforesaid electronic device having content displaying functionality, and includes the following steps.

Initially, in step 951, a graphics/text screen is displayed on the sensing screen 11 of the screen sensing input unit 1.

Subsequently, in step 952, the processing unit 2 detects whether the user is using an object (e.g., an index finger 3) to touch the sensing screen 11 so that the processing unit 2 detects a touch at a touch point of the sensing screen 11 that results in generation of an input signal. If yes, the flow goes to step 953, in which the processing unit 2 enables display of a local enlarged screen 118 on the sensing screen 11 in the vicinity where the index finger 3 touches the sensing screen 11, as shown in FIG. 19. If no, the processing unit 2 continues to detect presence of any input signal.

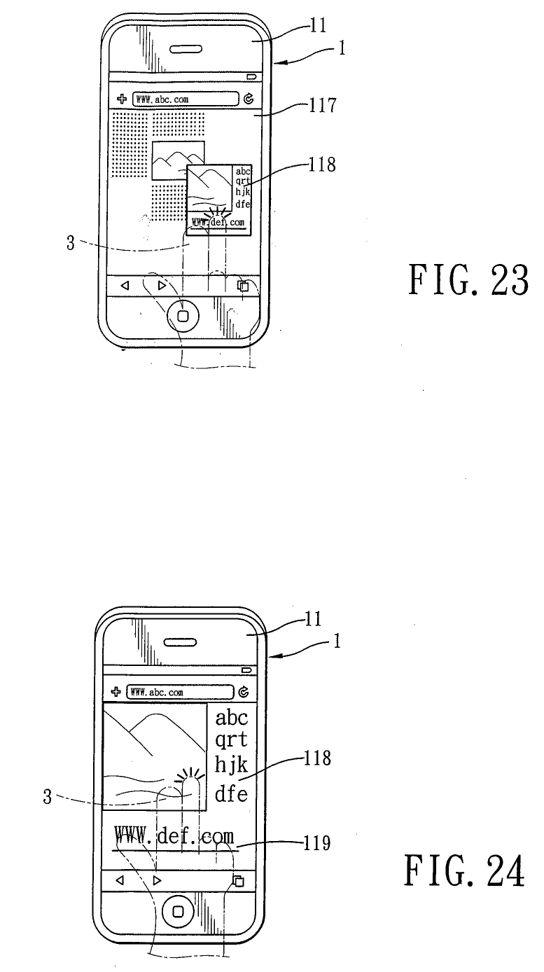

Thereafter, the flow goes to step 954, in which the processing unit 2 detects whether the user is using an object (e.g., an index finger 3) and another object (e.g., a middle finger 3) to touch the sensing screen 11 substantially simultaneously, so that the processing unit 2 detects touching at two touch points on the sensing screen 11 which result in generation of a confirm input signal, as shown in FIG. 23. If yes, the flow goes to step 955, in which the local enlarged screen 118 is fully zoomed out to fit the sensing screen 11, and is set to an advanced operating state.

Subsequently, the flow goes to step 956, in which the processing unit 2 detects whether the user is using his/her index and middle fingers 3 to touch the local enlarged screen 118 that is fully zoomed out on the sensing screen 11 so that the processing unit 2 detects touching at two touch points on the sensing screen 11, as shown in FIG. 24. If yes, the sensing screen 11 reverts back to displaying the graphics/text screen 117 in full-screen, as shown in FIG. 17. If no, display of the local enlarged screen 118 in full-screen is maintained.

In the input method and the content displaying method for an electronic device according to the present invention, although the former is employed in input of data via the virtual keys 111 and the latter is used in operating the graphics/text screen 117, they are both directed to the use of input signals and confirm input signals so as to render input of data and operation of the electronic device more user-friendly.

In sum, the present invention has the following advantages:

1. The present invention enhances input efficiency and operational ease by use of software without increasing hardware costs. However, it should be noted that the present invention may also be implemented using hardware means.

2. In terms of input operation on the electronic device, the use of prompts and the arrangement of increased distances among the virtual keys 111 increase considerably the accuracy of data input.

3. In terms of the content displaying method of the electronic device, the user is able to view a full-screen graphics/text screen 117. Although the resolution and size of the sensing screen 11 may not be satisfactory, the method permits instant zooming, advanced operation and restoring to original full-screen view by touch, thereby making reading of webpage content more user-friendly.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An input method for an electronic device having a sensing screen, said input method comprising the following steps:
(a) displaying a plurality of virtual keys on the sensing screen;
(b) receiving an input signal provided by the sensing screen;
(c) displaying an enlarged virtual key corresponding to the input signal on the sensing screen;
(d) detecting whether there is an input of a confirm input signal provided by the sensing screen; and
(e) outputting a virtual key code corresponding to the confirm input signal upon detection of the confirm input signal.

2. The input method for an electronic device according to claim 1, wherein, in step (a), the virtual keys are displayed in a plurality of virtual key groups.

3. The input method for an electronic device according to claim 2, wherein, in step (a), each of the virtual key groups has one virtual key unique to said one of the virtual key groups and displayed conspicuously, and adjacent ones of the virtual key groups have a common one of the virtual keys as members thereof.

4. The input method for an electronic device according to claim 2, wherein step (c) further includes a sub-step of displaying enlarged virtual keys corresponding to the virtual keys in one of the virtual key groups that corresponds to the input signal.

5. The input method for an electronic device according to claim 1, wherein step (a) includes a sub-step: setting a plurality of first sensing areas located respectively at central portions of the virtual keys and corresponding respectively to the virtual keys, a plurality of second sensing areas located respectively at peripheral portions of the virtual keys and corresponding respectively to the virtual keys, and a plurality of third sensing areas located among the virtual keys.

6. The input method for an electronic device according to claim 5, further comprising, between steps (b) and (c):
(d) outputting a virtual key code corresponding to the input signal if the input signal is generated by touching at the first sensing area of one of the virtual keys.

7. The input method for an electronic device according to claim 5, wherein the input signal in step (b) is generated by touching at one of the third sensing areas or one side of one of the second sensing areas that is adjacent to said one of the third sensing areas and that corresponds to one of the virtual keys.

8. The input method for an electronic device according to claim 7, wherein, in step (c), enlarged virtual keys corresponding to the virtual keys adjacent to two sides of said one of the third sensing areas or adjacent to two sides of said one of the second sensing areas are displayed.

9. A content displaying method for an electronic device provided with a sensing screen, said content displaying method comprising the following steps:
(a) displaying a graphics/text screen on the sensing screen;
(b) receiving an input signal provided by the sensing screen and obtaining a touch position from the input signal;
(c) displaying a local enlarged screen obtained by enlarging a portion of the graphics/text screen in the vicinity of the touch position;
(d) detecting whether there is an input of a confirm input signal provided by the sensing screen; and
(e) upon detection of the confirm input signal, positioning the local enlarged screen and setting the local enlarged screen to an advanced operating state.

10. The content displaying method for an electronic device according to claim 9, wherein the local enlarged screen is displayed in full-screen, said content displaying method further comprising, after step (e):
(f) detecting whether the confirm input signal is inputted within the local enlarged screen, and stopping display of the local enlarged screen if affirmative.

11. The content displaying method for an electronic device according to claim 9, further comprising, after step (e)
(g) detecting whether the input signal or the confirm input signal is inputted outside the local enlarged screen, and stopping display of the local enlarged screen if affirmative.

12. The content displaying method for an electronic device according to claim 9, wherein, in step (a), the graphics/text screen is that of a hypertext document having at least one hypertext link.

13. The content displaying method for an electronic device according to claim 12, wherein, in step (e), the advanced operating state permits selection of the hypertext link to view another hypertext document.

14. An electronic device having input functionality, comprising:
a screen sensing input unit including a sensing screen capable of generating an input signal and a confirm input signal; and
a processing unit connected electrically to said screen sensing input unit, said processing unit including a detecting module, a determining module, and a screen outputting module;
wherein said screen outputting module generates a plurality of virtual keys for display on said sensing screen, said detecting module receives the input signal and the confirm input signal from said sensing screen, and said determining module enables display of a corresponding enlarged virtual key on the sensing screen through said screen outputting module for operation by a user upon detection of the input signal by said detecting module, and outputs a virtual key code corresponding to the confirm input signal upon detection of the confirm input signal by said detecting module.

15. The electronic device having input functionality according to claim 14, wherein the virtual keys are displayed on said sensing screen in a plurality of virtual key groups.

16. The electronic device having input functionality according to claim 15, wherein each of the virtual key groups has one virtual key unique to said one of the virtual key groups and displayed conspicuously, and adjacent ones of the virtual key groups have a common one of the virtual keys as members thereof.

17. The electronic device having input functionality according to claim 15, wherein said determining module enables display of enlarged virtual keys corresponding to the virtual keys in one of the virtual key groups that corresponds to the input signal on said sensing screen through said screen outputting module upon detection of the input signal by said determining module.

18. The electronic device having input functionality according to claim 14, wherein said processing unit sets a plurality of first sensing areas located respectively at central portions of the virtual keys and corresponding respectively to the virtual keys, a plurality of second sensing areas located respectively at peripheral portions of the virtual keys and corresponding respectively to the virtual keys, and a plurality of third sensing areas located among the virtual keys.

19. The electronic device having input functionality according to claim 18, wherein said determining module of said processing unit outputs a virtual key code corresponding to the input signal when said determining module detects that the input signal is generated by touching at the first sensing area of one of the virtual keys.

20. The electronic device having input functionality according to claim 18, wherein the input signal is generated by touching at one of the third sensing areas or one side of one of the second sensing areas which is adjacent to said one of the third sensing areas and which corresponds to one of the virtual keys.

21. The electronic device having input functionality according to claim 20, wherein said determining module of said processing unit enables display of enlarged virtual keys corresponding to the virtual keys adjacent to two sides of said one of the third sensing areas or adjacent to two sides of said one of the second sensing areas on said sensing screen through said screen outputting module upon detection of the input signal by said determining module.

22. An electronic device having content displaying functionality, comprising:
a screen sensing input unit including a sensing screen capable of generating an input signal and a confirm input signal, said sensing screen being capable of displaying a graphics/text screen; and
a processing unit connected electrically to said screen sensing input unit and including a detecting module, a determining module, and a screen outputting module, wherein said screen outputting module is used to process the graphics/text screen for displaying by said sensing screen, said detecting module is used to receive the input signal and the confirm input signal from said sensing screen, and said determining module computes a touch position according to the input signal, said determining module enabling display on said sensing screen of a local enlarged screen in the vicinity of the touch position through said screen outputting module upon detection of the input signal by said detecting module, said determining module positioning the local enlarged screen through said screen outputting module and setting the local enlarged screen to an advanced operating state upon detection of the confirm input signal by said detecting module.

23. The electronic device having content displaying functionality according to claim 22, wherein the local enlarged screen is displayed in full-screen, and said processing unit detects whether the confirm input signal is inputted within the local enlarged screen, and stops display of the local enlarged screen if affirmative.

24. The electronic device having content displaying functionality according to claim 22, wherein said determining module of said processing unit detects whether the input signal or the confirm input signal is inputted outside the local enlarged screen, and stops display of the local enlarged screen if affirmative.

25. The electronic device having content displaying functionality according to claim 22, wherein said graphics/text screen is that of a hypertext document having at least one hypertext link, and the advanced operating state permits selection of the hypertext link to view another hypertext document.

26. An input system for an electronic device provided with a sensing screen, said input system comprising:
a screen outputting module for generating a plurality of virtual keys for display on the sensing screen;
a detecting module for receiving an input signal and a confirm input signal from the sensing screen; and
a determining module for enabling display of a corresponding enlarged virtual key on the sensing screen through said screen outputting module for operation by a user upon detection of the input signal by said detecting module, and for outputting a virtual key code corresponding to the confirm input signal upon detection of the confirm input signal by said detecting module.

27. A content displaying system for an electronic device provided with a sensing screen capable of displaying a graphics/text screen, said content displaying system comprising:
a screen outputting module adapted to process the graphics/text screen for display on the sensing screen;
a detecting module adapted to receive an input signal and a confirm input signal from the sensing screen; and
a determining module for computing a touch position according to the input signal, for enabling display on the sensing screen of a local enlarged screen in the vicinity of the touch position through said screen outputting module upon detection of the input signal by said detecting module, and for positioning the local enlarged screen through said screen outputting module and setting the local enlarged screen to an advanced operating state upon detection of the confirm input signal by said detecting module.
